(19) United States
(12) Patent Application Publication
(10) Pub. No.: US 2009/0020078 A1
(43) Pub. Date: Jan. 22, 2009

(54) Animal Leash

(76) Inventor: Grady Johnson, San Jose, CA (US)

Correspondence Address: James M. Wu;JW Law Group, 84 W. Santa Clara Street, Suite 820, San Jose, CA, 95113, US

(21) Appl. No.: 11/781,257

(22) Filed: Jul. 22, 2007

(51) Int. Cl. A01K 27/00

(52) U.S. Cl. 119/795

(57) ABSTRACT

For some embodiments, a leash includes a primary loop and a secondary loop. The primary loop may be used to grasp the leash. The secondary loop may be used to enable strengthening the grasp of the leash. The secondary loop may be smaller than the first loop.

### FIELD OF THE INVENTION

Embodiments of the invention relate generally to methods and apparatus to hold or grasp an object, and more specifically but not limited to grasping leash to secure animals.

### BACKGROUND

FIG. 1A is a diagram illustrating an example of a traditional leash that may be used to maintain movement control of an animal. Generally, a leash may be used to restrain an animal from wandering too far away from a leash holder that the animal is accompanying. In the current example, the animal is a dog 125 but other animals may also apply. The leash holder 105 may hold leash 110 by grasping a loop 115 at one end of the leash 110. Typically, the loop 115 is formed by bending the end of the leash 110 and attaching the end to a section of the leash 110. At the other end of the leash 110 may be a releasable latch or connecting device 112 which may enable the leash to be attached to an animal collar 120. The animal collar 120 may then be wrapped loosely around the neck of the dog 125.

One common problem with animals is that they generally tend to be easily distracted. The distraction can be anything including, for example, presence of other nearby animals. When this occurs, the dog 125 may ignore the fact that it is constrained by the leash 110 and may try to force its way toward the direction of the distraction, often with the leash holder 105 trailing behind. FIG. 1B illustrated an example of how the leash 110 is held in the hand of a person. Typically, the four fingers other than the thumb are inserted into the loop 115 and form a closed grip around the loop 115 with the thumb and the palm of the hand. In situations when the dog 125 is strong and/or large, the loop 115 may slip from the hand of the leash holder 105, and the dog 125 may run loose. This can be potentially dangerous since the dog 125 may cause injuries to others. One technique that is commonly used to constrain a distracted or uncooperative dog is to wrap the leash 110 several times around the hand of the leash holder 105 in order to obtain a stronger grasp. However, this technique is not desirable because it requires the leash holder 105 to perform the wrappings quickly against the stretching tension of the leash 110 caused by the dog 125.

### SUMMARY OF THE INVENTION

In accordance with some embodiments of the invention, there is provided a leash which incorporates a loop into a section of the leash to enable strengthening grasp of the leash. This may enable maintaining movement control of the leashed animal. The loop may have a sufficient size to accommodate a leash holder to insert one or more fingers to strengthen the grasp of the leash.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is a diagram illustrating an example of a leash.

FIG. 1B illustrates an example of how a leash is typically used.

FIG. 2 illustrates an example of an improved leash, in accordance with some embodiments.

FIGS. 3A-3C illustrate examples of how the improved leash may be used to control an animal, in accordance with some embodiments.

FIGS. 4A-4B illustrate examples of an improved leash, in accordance with some embodiments.

FIG. 5 illustrates another example of an improved leash, in accordance with some embodiments.

### DETAILED DESCRIPTION

For some embodiments, a leash having a loop to maintain control of an animal is disclosed. The loop may enable a person who is holding one end of the leash to optionally insert one or more fingers to strengthen the grasp of the leash.

In the following detailed description, numerous specific details are set forth. However, it is understood that embodiments of the invention may be practiced without these specific details. In other instances, well-known structures and techniques have not been shown in detail in order to not obscure the understanding of this description. These embodiments are described in sufficient detail to enable those of ordinary skill in the art to practice the invention. The following detailed description is, therefore, not to be taken in a limiting sense, and the scope of the invention is defined only by the appended claims.

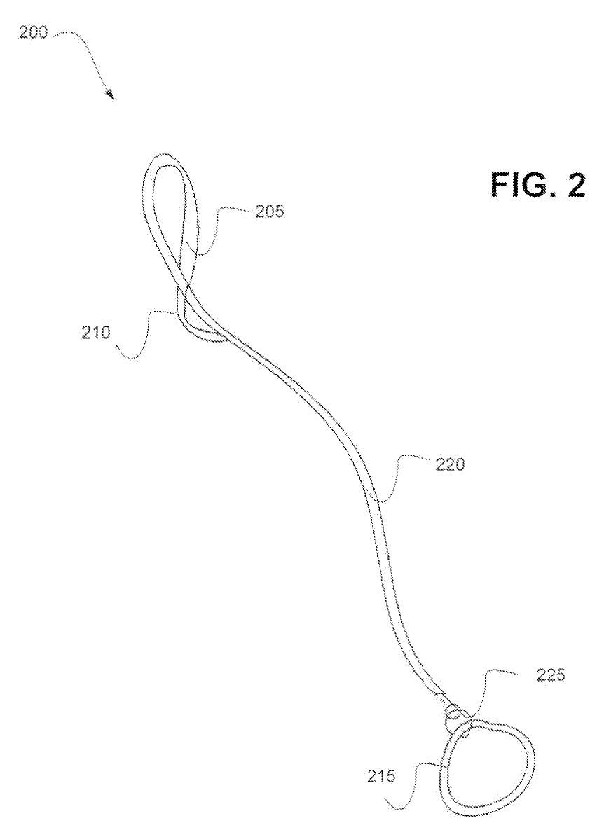

FIG. 2 illustrates an example of an improved leash, in accordance with some embodiments. The improved leash may include multiple sections designed to enable a person to grasp the leash and to optionally strengthen the grasp of the leash. Strengthening the grasp of the leash may prevent the leash from being pulled off and away from the hand of the person. In the current example, leash 200 may include a primary loop 205 and a secondary loop 210.

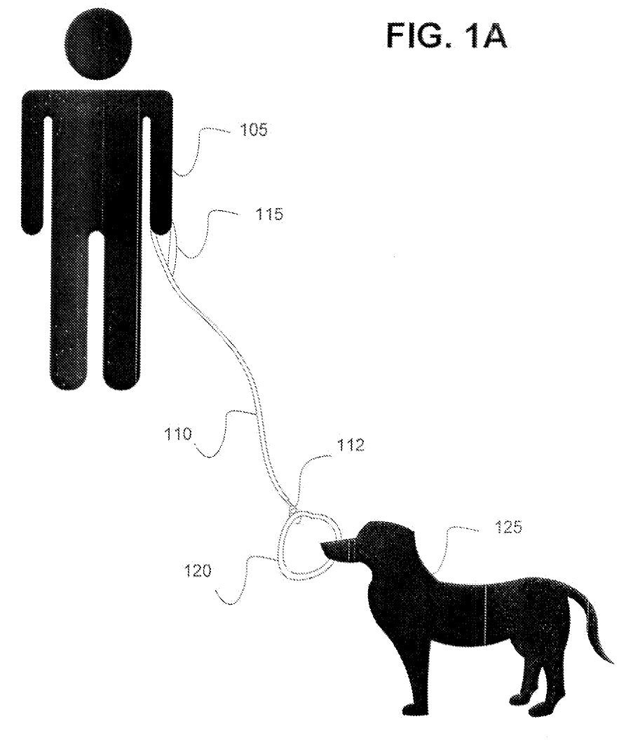

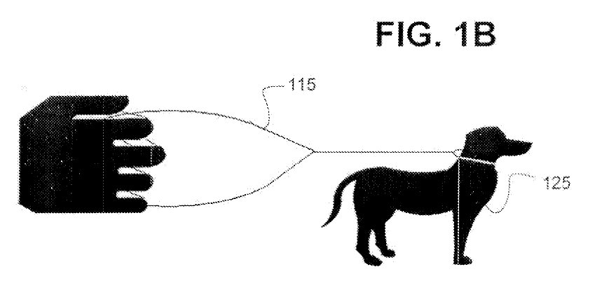

As can be seen, the primary loop 205 may be similar to the loop 115 illustrated in FIGS. 1A and 1B and may normally be used to grasp the leash 200. The secondary loop 210 may be positioned approximately adjacent to the primary loop 205 in the direction of collar 215. The leash 200 may also include extension section 220 that extends from the direction of the primary loop 205 and the secondary loop 210 toward device 225 that may be used to connect to the collar 215. The device 225 may be a releasable clip, latch, locking device, etc. For some embodiments, the primary loop 205, the secondary loop 210 and the extension 220 may be manufactured using the same material. For example, the leash 200 may be a flexible line made of nylon or leather. It may be noted when the secondary loop 210 is not used, the secondary loop 210 may be flat. The line may be one half inch wide and may be several feet long. One end of the line may be attached to a releasable latch or clip to be connected to a collar. The other end of the line may be folded over to form the primary loop 205 and then the secondary loop 210. The formation of the primary loop 205 and the secondary loop 210 may require several sections of the line to be attached together. Different attaching techniques (e.g., sewing, molding, etc.) may be used.

For some other embodiments, one or more of the primary loop 205, the secondary loop 210, and the extension section 220 may be manufactured using different materials. For example, the primary loop 205 may be manufactured using leather, the secondary loop 210 may be manufactured using a metallic material, and the extension section 220 may be manufactured using nylon.

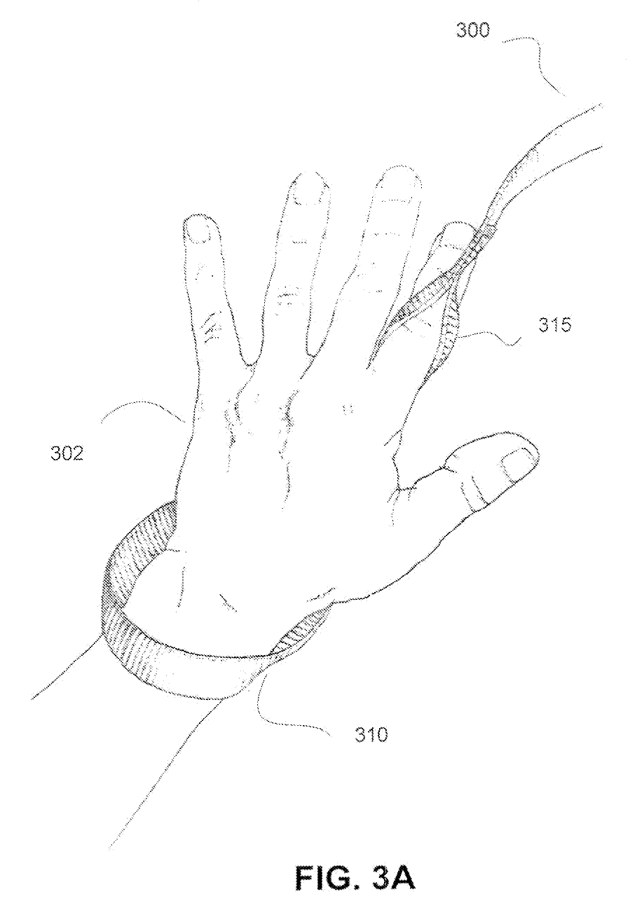

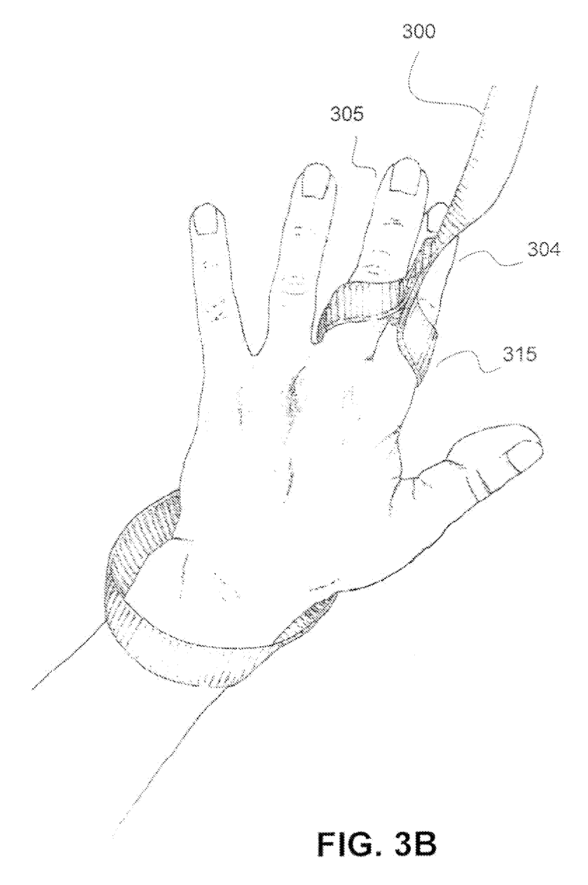

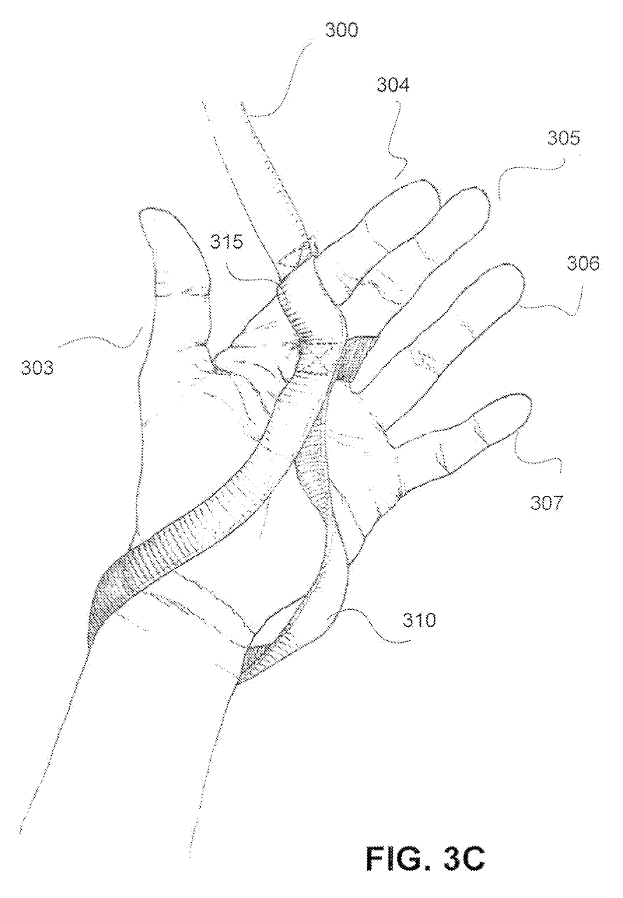

FIG. 3A illustrates an example of how an improved leash may be used to control an animal, in accordance with some embodiments. In certain situations, grasping a leash using the primary loop by itself may not be sufficient. When this occurs, it may be advantageous to grasp the leash using both the primary loop and the secondary loop. In the current example, hand 302 may be used to grasp leash 300 which may include a primary loop 310 and a secondary loop 315.

For some embodiments, the index finger 304 and the middle finger 305 may be used together with the secondary loop 315 to strengthen the grasp of the leash 300. This is illustrated in FIG. 3B. Bending the index finger 304 and the middle finger 305 may form a closed grip of the secondary loop 315 with the palm, while the ring finger 306 and the pinky finger 307 may also follow the index finger 304 and the middle finger 305 toward the palm. Bending the thumb 303 toward the palm may form a more complete closed grip with the palm.

Although the index finger 304 and the middle finger 305 are used in these examples, it is possible for a person to use a combination of one or more of the index finger 304, the middle finger 305, and the ring finger 306. It may also be possible that the combination of fingers used with the secondary loop may also include the pinky finger 307, in which case the size of the secondary loop 315 may need to be larger.

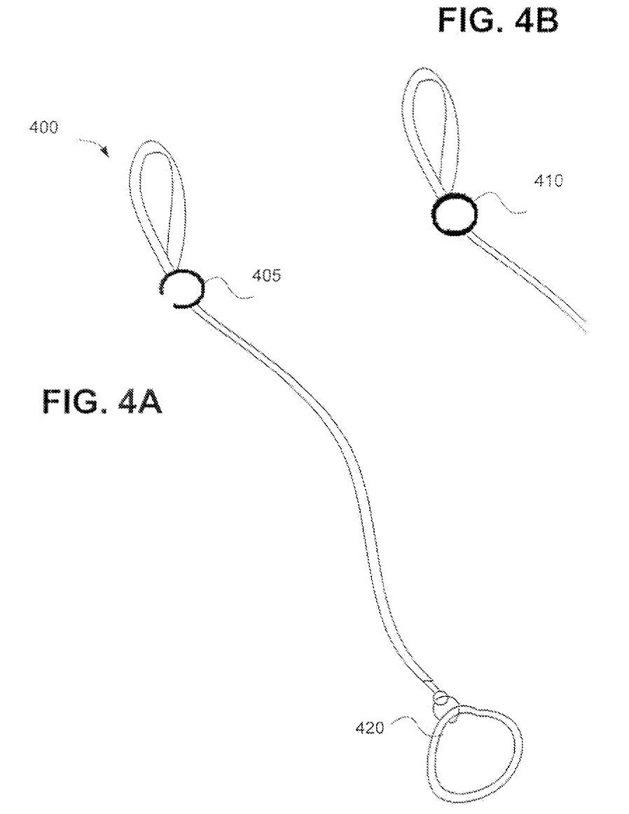

FIGS. 4A-4B illustrate other examples of an improved leash, in accordance with some embodiments. The secondary loop described in the examples illustrated in FIG. 2 and FIGS. 3A-3C may be in any form as long as they are sufficiently large enough to insert the fingers to strengthen the grasp of the leash. As such, the secondary loop may be in any shape or form. For example, the secondary loop may be oval, circular, square, rectangle, or any geometrical shape that forms a loop. For some embodiments, the secondary loop may not necessarily be a closed loop, as long as it enables the ability to strengthen the grasp of the leash. FIG. 4A illustrates an example of a secondary loop that is not a closed loop. As described above, the secondary loop may not be manufactured using the same material as the primary loop or the extension section. For example, the secondary loop may be a metallic circle, as illustrated in FIG. 4B.

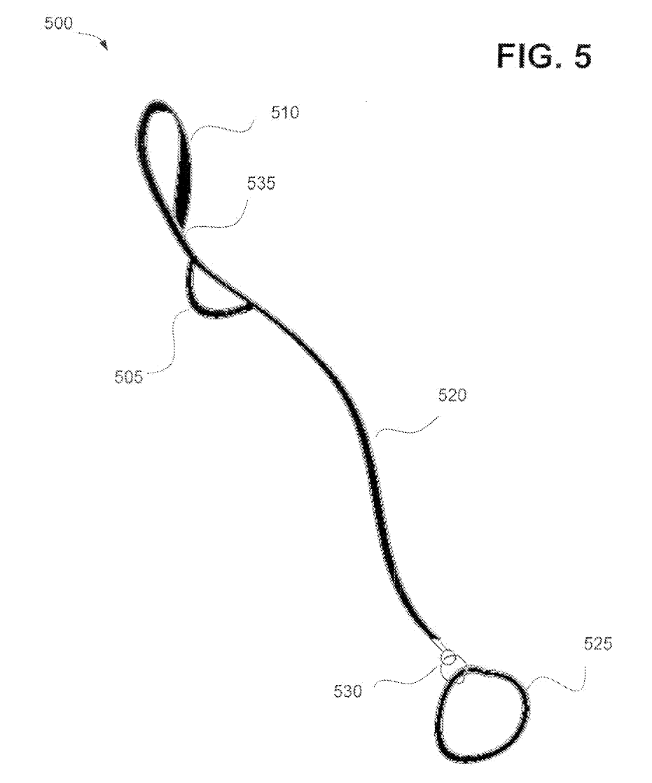

FIG. 5 illustrates another example of an improved leash, in accordance with some embodiments. The secondary loop may be immediately adjacent to the primary loop. For some embodiments, the secondary loop may be positioned apart from the primary loop. In the current example, the leash 500 may include a primary loop 510, a secondary loop 505, the extension section 520, the connecting device 530, and the collar 525. As illustrated, the secondary loop 505 is separated from the primary loop 510 by the intervening section 535. The intervening section 535 may be short in length. This may enable a person to extend some fingers and be able to quickly insert these fingers into the secondary loop 505.

Embodiments of a method for strengthening the grasp of a leash, a strap, or other similar devices are described herein. In the above description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring the description.

The above description of illustrated embodiments of the invention, including what is described in the abstract, is not intended to be exhaustive or to be limitation to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation.

What is claimed is:

1. A leash used to control an animal, comprising:
a primary loop for a first level of control;
a secondary loop coupled to the primary loop for a second level of control, wherein the secondary loop is held using one or more fingers of a person's hand; and
a releasable latch coupled to the secondary loop and positioned between the secondary loop and an animal collar.

2. The leash of claim 1, further comprising an extension section that extends from the secondary loop to the releasable latch.

3. The leash of claim 2, wherein the secondary loop is positioned adjacent to the primary loop.

4. The leash of claim 2, wherein the secondary loop is positioned within a short distance from the primary loop.

5. The leash of claim 2, wherein the primary loop, the secondary loop and the extension section are manufactured using a similar material.

6. The leash of claim 2, wherein the primary loop and the secondary loop are manufactured using different materials.

7. The leash of claim 2, wherein the secondary loop is held using one or more of an index finger, a middle finger, a ring finger and a pinky finger.

8. The leash of claim 7, wherein the second level of control enables strengthening grasp of the leash when used together with the first level of control.

9. A method of securing an animal using a leash, comprising:
providing a first loop for a person to have a hold of the leash, the first loop positioned at a first end of the leash; and
providing a second loop near the first loop, the second loop enabling the person to optionally use to obtain a stronger hold of the leash.

10. The method of claim 9, further comprising attaching a second end of the leash to a releasable locking device to connect to an animal collar.

11. The method of claim 9, wherein the person is to have the stronger hold of the leash by holding on to both the first loop and to the second loop.

12. The method of claim 11, wherein the person uses one or more of index finger, middle finger, ring finger, and pinky finger with the second loop.

13. The method of claim 9, wherein the first loop is positioned next to the second loop.

14. The method of claim 9, wherein the first loop and the second loop are manufactured using a similar material.

15. An animal leash, comprising:
a flexible line;
a first loop positioned at a first end of the flexible line and configured to accommodate insertion of a hand of a user of the leash; and
a second loop positioned between the first loop and a second end of the flexible line, the second loop configured to accommodate insertion of one or more fingers associated with the hand of the user.

16. The animal leash of claim 15, wherein the second loop is positioned close to the first loop.

17. The animal leash of claim 15, wherein the flexible line is manufactured using nylon.

18. The animal leash of claim 15, wherein the flexible line is manufactured using leather.

19. The animal leash of claim 15, wherein the second loop is manufactured using a different material from a material used to manufacture the flexible line.

20. The animal leash of claim 15, wherein the second loop is smaller than the first loop.
